(19) United States
(12) Patent Application Publication
(10) Pub. No.: US 2013/0236070 A1
(43) Pub. Date: Sep. 12, 2013

(54) AUTOMATIC FACE DETECTION AND PARENTAL APPROVAL IN IMAGES AND VIDEO AND APPLICATIONS THEREOF

(71) Applicant: DIY, CO., San Francisco, CA (US)

(72) Inventor: Andrew Sliwinski, Oakland, CA (US)

(73) Assignee: DIY, CO., San Francisco, CA (US)

(21) Appl. No.: 13/795,282

(22) Filed: Mar. 12, 2013

Related U.S. Application Data
(60) Provisional application No. 61/609,700, filed on Mar. 12, 2012.

(51) Int. Cl. G06K 9/00

(52) U.S. Cl. CPC G06K 9/00221
USPC 382/118

(57) ABSTRACT

A method and system for the notification and subsequent approval process corresponding to facial detection in images and videos disclosed by or related to minors or other dependents within an online platform. A face detector is applied to detect a set of possible face regions in the image or video. If a face is detected within a given threshold of certainty, the image or video (media) is flagged for approval by the minor's and/or dependent's parent, agent, representative or legal guardian.

### CROSS-REFERENCE TO RELATED APPLICATIONS

This application claims the benefit of U.S. Provisional Application 61/609,700, entitled AUTOMATIC FACE DETECTION AND PARENTAL APPROVAL IN IMAGES AND VIDEO AND APPLICATIONS THEREOF, filed on Mar. 12, 2012, which is hereby incorporated by reference herein in its entirety.

### BACKGROUND

### Field

There exists a need for image and video processing, and more particularly to identity protection by automatically detecting and providing the parents and legal guardians a method for approval of detected media and applications thereof.

### SUMMARY

Systems and methods described herein provide for processing of media images for identity protection by detecting and providing the parents and legal guardians of others a method for approval of detected media and applications thereof.

Systems and methods described herein may comprise a detection facility configured to use a computer processor to detect a face of a child in a media image within a threshold of certainty and place a restriction on the availability of the media image. In embodiments, the detection facility may then present the detected media image to a legal representative of the child, minor, or other individual and request and/or receive input from the legal representative related to the image. In embodiments, the detection facility may maintain a restriction on the availability of the media image until the input comprises legal representative approval.

In embodiments, the image may be at least one of a photograph, and a video. In embodiments, the legal representative may comprise at least one of a parent, a guardian, an educator, a government representative, an attorney, and the like. In embodiments, the term child used herein may refer to any one or more of an individual dependent on another due to mental illness, advanced age, and the like; an individual who relies on an agent, for example a celebrity, client, executive, and the like.

In embodiments, the detection facility may be applied to one or more social networking pages and/or the results of an Internet search such that such image detection is applied to the social networking pages and/or the search results. In embodiments, such application of the detection facility may be applied automatically. In embodiments, the legal representative may be prompted to provide analysis to the detection facility of the media image where the image is categorized based on such analysis. The image detection facility may categorize the image based on the analysis. In embodiments, the analysis provided may comprise a determination that the media image does not contain a face in the image and/or that the media image does not contain an image of a child, or other individual, associated with said legal representative.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a diagram of a system for performing facial detection on media that may be viewed through a network.

FIG. 2 depicts a flow chart of a process for identity detection and parental verification of user submitted media.

FIG. 3 depicts a process for improving the identity detection system through user feedback.

FIG. 4 depicts a wireframe of an exemplary interface for the parental approval of a user's submitted media that has been deemed to be personally identifying.

FIG. 5 depicts a wireframe of an exemplary interface for the notification to a user that a parent has rejected a unit or multiple units of media.

FIG. 6 depicts an embodiment of a system or method for performing facial detection.

While the invention has been described in connection with certain preferred embodiments, other embodiments would be understood by one of ordinary skill in the art and are encompassed herein.

All documents referenced herein are hereby incorporated by reference in their entirety.

### DETAILED DESCRIPTION

The present invention relates to protecting the identity of minors and other dependent individuals within a computer network system by automatically detecting faces within submitted media and subjecting subsequent media to parental verification. In an embodiment, a face detector detects a set of possible face regions in an image or within the frames of a video. Media found to contain a face within a set threshold of probability are then automatically protected until such time as the user's parent provides consent for the release of the media within the computer network. Although this disclosure generally describes the present invention in terms of approval from a parent, other legal representatives and/or entities may also provide approval, such as legal guardians, educators, government personal, agents, attorneys, corporations and the like. Furthermore, while this disclosure generally describes the present systems and methods in terms of approving images and/or data related to a child, other persons may also depend on another for consent for the release of media containing their face and/or other information. Such other persons or dependents may include dependent persons for various reasons such as those with mental disabilities, advanced age, principals in an agent-principal relationship, and the like. By way of example an agent of a celebrity may be able to approve or disapprove the use of the celebrity's image or the care provider for an elderly individual may be able to approve or disapprove the use of the elderly individual's image, by way of example.

In one embodiment, to make sure identities in media are detected, the sensitivity of the face detector can be adjusted to detect possible regions that may correspond to a face. Then, user feedback regarding false positives (i.e., features which do not correspond to human faces in the media) may be used to further improve the accuracy of the detection system, for example by means of an adaptive system. Such an adaptive system may be implemented through the use of an artificial neural network. In embodiments, input dimension reduction may be utilized in conjunction with the neural network as to ensure that the input vector can be scaled. By way of example, in embodiments, an input vector may be a collection of inputs to a neural network over time. In embodiments where training data becomes backlogged i.e. “piles up”, it may cause the neural network to become inefficient. In embodiments, input dimension reduction may be used to ensure that the input vector may be scaled without becoming inefficient, and/or without becoming so inefficient as to not be usable.

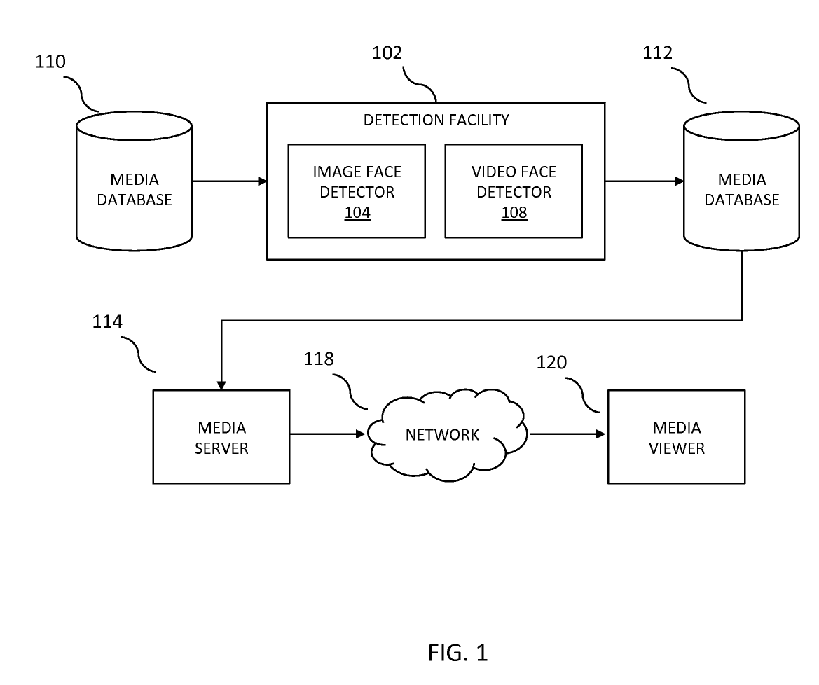

Referring to FIG. 1, a detection facility 102 (such as on a server on the Internet, a processor, and/or distributed processors and/or servers) may include an image face detector 104, a video face detector 108, and the like, with access to a media database 110 for media to be examined against a plurality of facial images. If the detection facility 102 detects a facial image of interest, the detection facility may forward the associated media to a second media database 112 for storing the media for access by a media server 114 for distribution to end-users across a network 118 to a media viewer 120.

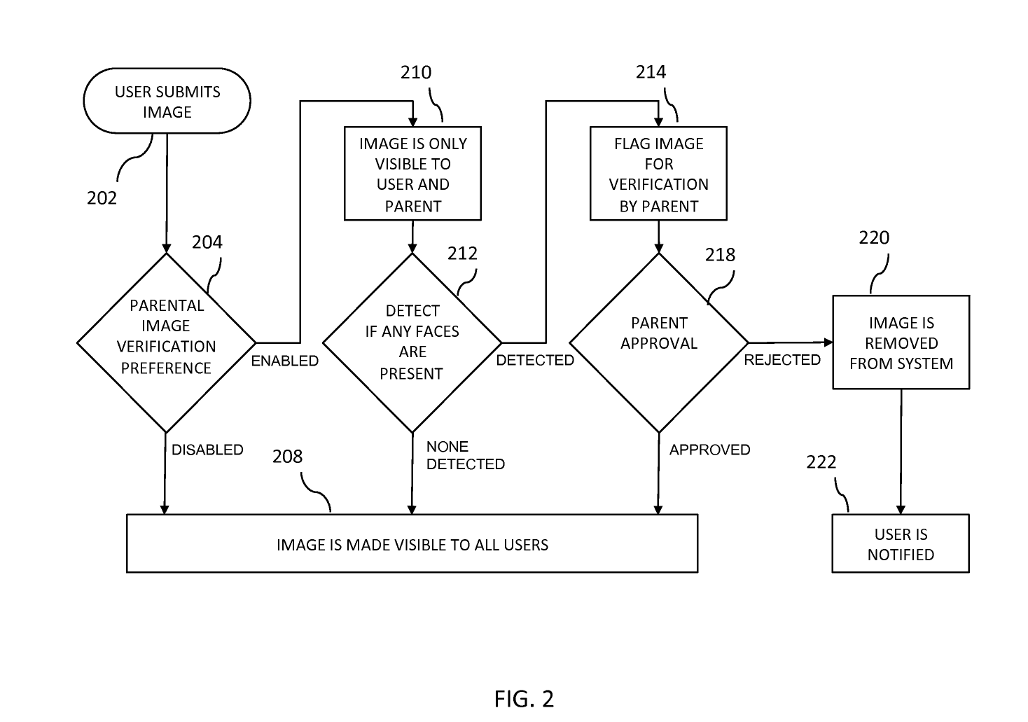

Referring to FIG. 2, an example embodiment process flow is depicted for the parental approval process in association with the detection facility. In a first step 202, a user may submit an image to the detection facility, and/or the detection facility may be applied to the results of an Internet search and/or one or more social network web pages. The detection facility may have a setting for a parental image verification preference 204, where if the setting is disabled, the image may be made visible to all users 208. If the preference is enabled, the image may only be visible to the user and the parent 210. In a next step, the detection facility may compare the image to a database of facial images associated with the parent 212, and if no match is detected, the image may be made visible to all users 208. If a match is detected, the image may be flagged for verification by the parent 214. If the parent approves the image, the image may be made visible to all users 208. If the parent rejects the image, then the image may be removed from the database 220, and the user that submitted the image may be notified 222. In embodiments, if the parent does not approve the image, the portion of the image containing the child may be removed from the media image. For example, a child's face may be blurred out or otherwise distorted in a media image such that it cannot be identified if a parent does not approve the image use.

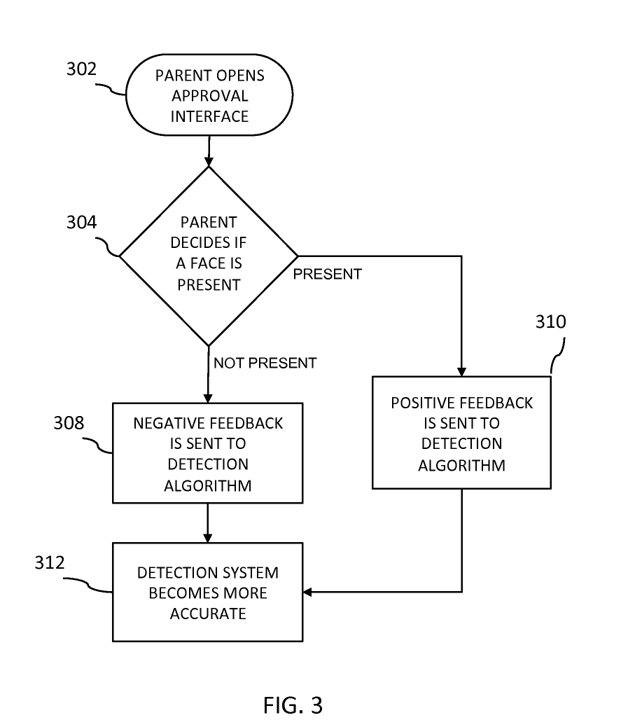

Referring to FIG. 3, an example embodiment process flow is depicted for feedback being utilized to make the detection process more accurate. At a first step, a parent may open the approval interface 302, such as after the parent has been notified of an image that may have a match to face detection. If the parent decides that a face is present in the image 304, positive feedback may be sent to the detection facility's detection algorithm 310. If the parent decides that a face is not present in the image, negative feedback may be sent to the detection algorithm 308. In this way, the detection system may become more accurate 312. In embodiments, if the parent decides that a face is present in the image, but the parent does not recognize the face as that of a minor associated with the parent, then negative feedback my be sent to the detection algorithm to improve accuracy of the algorithm.

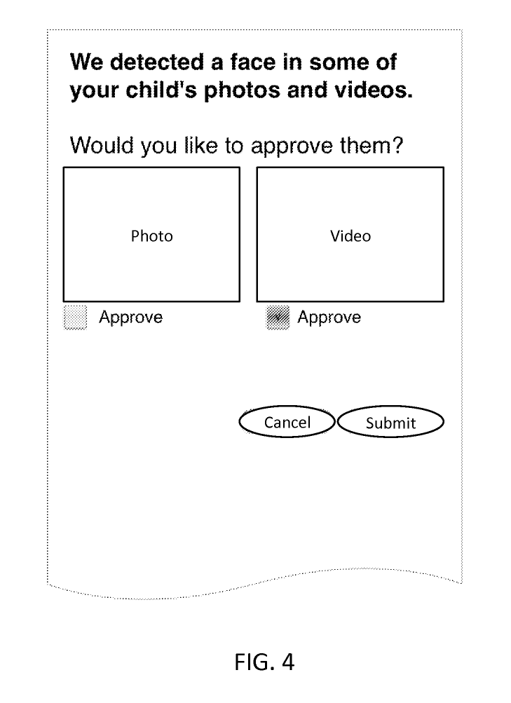

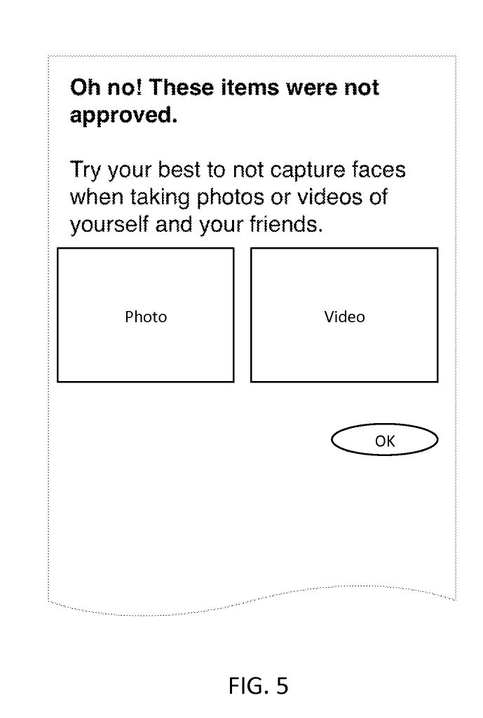

FIG. 4 depicts a wireframe of an exemplary interface for the parental approval of a user's submitted media that has been deemed to be personally identifying, such as including checkboxes for approval of photos, video, and the like. FIG. 5 depicts a wireframe of an exemplary interface for the notification to a user that a parent has rejected a unit or multiple units of media, such as with a presentation of the image to the user and a note describing the rejection.

In embodiments, the present invention may provide for a method and system for the notification and subsequent approval process corresponding to automatic facial detection and approval for use in digital media, such as photographic images, videos, and the like, disclosed by minors within an online platform. A face detector may be applied to detect a set of possible face regions in the media. If a face is detected within a given threshold of certainty, the media may be flagged for approval by the minor's legal representative, such as by their parent, legal guardian, educator, government representative, and the like. The method and system may comprise providing a face detection facility for detection of a face in a media image, wherein the face is the face of a child that is a minor; detecting a face in the media image, wherein the detecting is within a threshold of certainty; presenting the detected media image to a legal representative of the child for approval of the image of the child; and placing a restriction on the availability of the image in the media if the legal representative does not provide approval.

In embodiments, the present invention may provide for automatic face detection in the content of a social media site. A parent may be able to apply the automatic face detection facility to a set of social network user pages and search for their child's face amongst the pages. For example, a child may have a list of a dozen friends with a Facebook page. The parent may be able to input the Facebook friends list to the detection facility, and search for media images of their child. This may then be run periodically, such as once a week. The results from the detection scan may enable the parent to send communications to Facebook friends that have images that are not approved of by the parent (e.g. inappropriate images), such as by an email or text. The system and method may comprise providing a face detection facility for detection of a face in a social network media image, such as a digital photo, video, and the like, wherein the face is the face of a child that is a minor; specifying a list of social network contact names (e.g. a Facebook friends list) to the face detection facility; detecting a face in the social network media image of at least one of the list of social network sites specified by the list of social network contact names; presenting the detected media image to a legal representative of the child for approval of the image of the child; and sending an electronic communication (e.g., email, SMS) to at least one of the list of social network sites, wherein the communication specifies an action to be taken with regard to the media image.

In embodiments, a system and method may enable a parent to apply an automatic face detection facility to an Internet search, such as a Google images search, and then contact the host page with an email expressing a legal notice to restrict the use of the detected image. The system and method may comprise providing a face detection facility for the detection of a face in a media image found as the result of an Internet search, wherein the face is the face of a child that is a minor; running the Internet search for the minor's face; detecting the minor's face in a media image of the Internet search result; presenting the detected media image to a legal representative of the child; and sending an electronic communication to the host of the website associated with the detected media image, wherein the communication is a request for the restriction of use of the media image.

In embodiments, the present invention may provide for a detection-approval facility, such as including a detection server, engine, algorithm, media server, search engine, and the like. A detection engine may be image-based, video-based, include a threshold of detection, include a sensitivity setting, and the like. The search engine may have a search algorithm for finding faces in media, provide feedback to the system to improve accuracy, and the like. The detection-approval facility may have a communications facility, such as for providing a secure link between the system and a user.

A graphical user interface may be provided, such as for a user-side interface, a provider-side interface, and the like. The user-side interface may include a media viewer, an approval process facility, a secure login, and the like. The provider-side interface may include a media viewer, a detection engine interface, a policy facility, a settings facility (e.g. default, customizable to the user, customizable to the provider), automatic tagging, user management, media database management, a secure login, and the like.

The system may utilize a computer architecture that is server-client based, cloud-based, a client application, a software as a service (SaaS), and the like. The user device may be a personal computer, such as running a local application, web service, and the like. The user device may be a mobile device, such as a smart phone, tablet, and the like, where the system may be run as an application on the mobile device.

In embodiments, the present invention may provide for product features, such as stored user preferences, a user profile, policy preferences, history, and the like. The system and method may provide for a process flow including a step of inputting a media file, such as from a search result in a document, web page, across the Internet, on a social network site, and the like; a step of automatic detection, such as applied through preferences, sensitivity thresholds, with respect to past detections, and the like; a step of notification; a step of authorization; a step of feedback; and the like. Applications of the method and system may include personal media authorization, professional media authorization, website filtering, email filtering, an Internet photo service authorization, social media site approval (e.g. for Facebook), online video approval (e.g. YouTube), and the like. Environments for use may include a home website, a school website, social networks, email, SMS, and the like, and be used for approval from a legal representative, for automatic filtering (e.g., for a website, email), and the like. Markets for use may include personal markets, education markets, governmental markets, business markets, and the like.

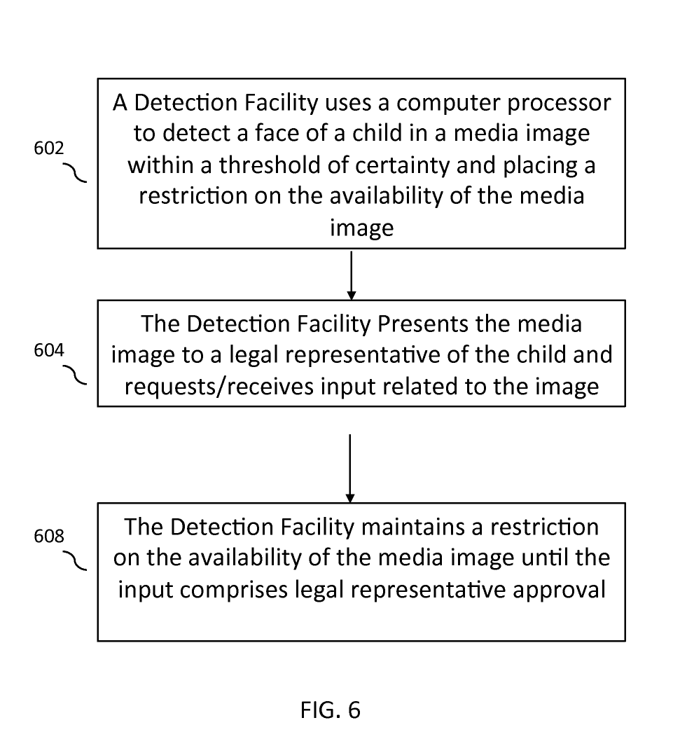

FIG. 6 provides an overview of an embodiment of systems and methods described herein. For example, a detection facility may use a computer processor to detect a face of a child in a media image within a threshold of certainty and place a restriction on the availability of the media image 602. The detection facility may then present the detected media image to a legal representative of the child and request and/or receive input from the legal representative related to the image 604. The detection facility may maintain a restriction on the availability of the media image until the input comprises legal representative approval 608. In embodiments, the image may be at least one of a photograph, and a video. In embodiments, the legal representative may comprise at least one of a parent, a guardian, an educator, a government representative, and the like. In embodiments, the term child used herein may refer to any one or more of an individual dependent on another due to mental illness, advanced age, and the like; an individual who relies on an agent, for example a celebrity, client, executive, and the like. In embodiments, the detection facility may be applied to one or more social networking pages and/or the results of an Internet search such that such image detection is applied to the social networking pages and/or the search results. In embodiments, such application of the detection facility may be applied automatically. In embodiments, the legal representative may be prompted to provide analysis to the detection facility of the media image where the image is categorized based on such analysis. The image detection facility may categorize the image based on the analysis. In embodiments, the analysis provided may comprise a determination that the media image does not contain a face in the image and/or that the media image does not contain an image of a child, or other individual, associated with said legal representative.

While the invention has been described in connection with certain preferred embodiments, other embodiments would be understood by one of ordinary skill in the art and are encompassed herein.

The methods and systems described herein may be deployed in part or in whole through a machine that executes computer software, program codes, and/or instructions on a processor. The present invention may be implemented as a method on the machine, as a system or apparatus as part of or in relation to the machine, or as a computer program product embodied in a computer readable medium executing on one or more of the machines. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method comprising:
providing a face detection facility for detection of a face in a media image, wherein the face is the face of a child that is a minor;
through the use of a computer processor, detecting a face in the media image, wherein the detecting is within a threshold of certainty;
placing a restriction on the availability of the media image;
presenting the detected media image to a legal representative of the child and requesting input related to the image of the child; and
maintaining the restriction on the availability of the media image until said input comprises legal representative approval of the media image.

2. The method of claim 1, wherein the media image is a photograph.

3. The method of claim 1, wherein the media image is part of a video.

4. The method of claim 1, wherein the legal representative of the child is at least one of a parent, a guardian, an educator, and a government representative.

5. The method of claim 1, wherein the detection facility is applied to one or more social networking pages.

6. The method of claim 1, wherein the detection facility is automatically applied to the result of an internet search and wherein said media image is found in said search.

7. The method of claim 1 further comprising,
prompting the legal representative to provide analysis of the media image; and
categorizing the media image based on said provided analysis.

8. The method of claim 7, wherein the provided analysis comprises a determination that the detected media image does not contain a face in the image.

9. The method of claim 7, wherein the provided analysis comprises a determination that the detected media image does not contain an image of a child associated with said legal representative.

10. A system comprising:
a detection facility adapted to detect a face in a media image wherein the detecting is within a threshold of certainty and wherein said face is that of a child who is a minor;
said detection facility further adapted to place a restriction on the availability of the media image;
said detection facility further adapted to present the media image to a legal representative when said detection facility detects a face of a child who is a minor associated with said legal representative;
said detection facility further adapted to receive input related to the image from said legal representative; and
said detection facility further adapted to maintain the restriction on the availability of the media image until said input comprises approval from said legal representative for the media image to be made available.

11. The system of claim 10, wherein the media image is a photograph.

12. The system of claim 10, wherein the media image is part of a video.

13. The system of claim 10, wherein the legal representative of the child is at least one of a parent, a guardian, an educator, and a government representative.

14. The system of claim 10, wherein the detection facility is applied to one or more social networking pages.

15. The system of claim 10, wherein the detection facility is automatically applied to the result of an internet search and wherein said media image is found in said search.

16. The system of claim 10, wherein the detection facility is further adapted to prompt the legal representative to provide analysis of the media image; and
wherein the detection facility is further adapted to categorize the media image based on said provided analysis.

17. The system of claim 12, wherein the provided analysis comprises a determination that the detected media image does not contain a face in the image.

18. The system of claim 12, wherein the provided analysis comprises a determination that the detected media image does not contain an image of a child associated with said legal representative.
